(19) United States
(12) Patent Application Publication
(10) Pub. No.: US 2017/0235661 A1
(43) Pub. Date: Aug. 17, 2017

(54) Integration of Software Systems via Incremental Verification

(71) Applicant: NetSuite Inc., San Mateo, CA (US)

(72) Inventors: Alan Liu, Palo Alto, CA (US); Ning Wang, Foster City, CA (US); Ryan Grisso, San Francisco, CA (US)

(21) Appl. No.: 14/196,968

(22) Filed: Mar. 4, 2014

Related U.S. Application Data
(60) Provisional application No. 61/772,655, filed on Mar. 5, 2013.

(51) Int. Cl. G06F 11/36; G06F 9/44

(52) U.S. Cl. CPC G06F 11/368; G06F 8/30

(57) ABSTRACT

Systems and methods for use in the development of software systems, applications, and platforms. Embodiments of the invention are directed to an efficient process for verifying or testing changes made to a code base for a software system. The inventive process provides the benefit of complete coverage obtained when using a verification process that is run over an entire software system, but with the efficiency associated with incremental software/code verification methods. In one embodiment, the inventive process involves constructing a mapping between the code base and a set of available verification tests, and then using that map to determine a subset of the available tests that are applicable to new or altered code. The invention also iteratively updates the map as new or changed code is added to the code base

### CROSS REFERENCE TO RELATED APPLICATION

This application claims the benefit of U.S. Provisional Application No. 61/772,655, entitled “Integration of Software Systems via Incremental Verification,” filed Mar. 5, 2013, which is incorporated herein by reference in its entirety (including the Appendix) for all purposes.

### BACKGROUND

Modern computer networks incorporate layers of virtualization so that physically remote computers and computer components can be allocated to a particular task and then reallocated when the task is done. Users sometimes speak in terms of computing “clouds” because of the way groups of computers and computing components can form and split responsive to user demand, and because users often never see the computing hardware that ultimately provides the computing services. More recently, different types of computing clouds and cloud services have begun emerging.

For the purposes of this description, cloud services may be divided broadly into “low level” services and “high level” services. Low level cloud services (sometimes called “raw” or “commodity” services) typically provide little more than virtual versions of a newly purchased physical computer system: virtual disk storage space, virtual processing power, an operating system, and perhaps a database such as an RDBMS. In contrast, high level cloud services typically focus on one or more well-defined end user applications, such as business oriented applications. Some high level cloud services provide an ability to customize and/or extend the functionality of one or more of the end user applications they provide; however, high level cloud services typically do not provide direct access to low level computing functions.

Whether a software application resides on a web server (i.e., in the cloud) or instead is installed on a local server or computing device, such applications may include or be part of a set of functional modules and data sources that together form a complex system capable of delivering a variety of services to users. Such systems may include functional modules of software code capable of providing user interfaces, database access, administrative functions, and specific applications (e.g., CRM (customer relationship management), ERP (enterprise resource planning), eCommerce, etc.), where the software for such systems may contain millions of lines of code. This code not only needs to be verified as accurate and capable of being executed properly when first installed, but also needs to be maintained and revised over time to correct for errors, upgrade its functionality, fix security problems, etc. The process of introducing new software code into a software system may be termed “integration” and typically in a software development environment, it is desirable to perform this integration process continuously as new code or functional modules (e.g., sub-routines, syntactic elements, etc.) become available. A continuous integration approach is adopted so as to not delay the updating or correcting of the code being used to provide services to customers. And, when introducing new code into a code base, it is important that the new code operates correctly and also that it is compatible with the previously existing code.

Methods presently exist for verifying the code contained in a complex software system. However, known methods typically suffer from one or more disadvantages, such as requiring a large amount of time to implement, increasing the cost of software development, delaying release of the system, creating a bottleneck in the development cycle, etc.

For example, a relatively straight-forward but inefficient method of verifying a large software system involves running a series of verification tests on the entire set of code contained in the system. However, these tests can be time consuming, taking hours or even days to execute, and if several different code development branches need to be verified, then this can represent a significant operational cost. It can also become a developmental bottleneck for an organization that is attempting to modify the software system, as portions of the overall development effort may be dependent on the successful completion and verification of earlier tasks.

As noted, a large software system can consist of hundreds of functional modules and millions of lines of code. Each module may perform one or more specific functions (e.g., generating a user interface, processing data input by a user, accessing a database, preparing data for transmission over a communications channel, etc.), with the modules being combined into an overall system or data processing platform that has a defined data and process flow. The verified and accepted software code for the overall system may be termed the “code base” for that system. In a continuous integration software development environment, each proposed change to the code base is typically required to pass certain verification processes (such as regression tests) before being added to and incorporated into the code base.

However, performing regression testing and/or other types of verification processes can be a time consuming procedure. It is also inefficient, as each code change typically only impacts a small portion of the code base, and many of the available regression or other tests may not be applicable to the changed section of code. Having to perform each of a set of regression or other verification tests every time a code change is proposed (or a new module/sub-routine/syntactic element is added) to any part of a code base is therefore inefficient, wastes resources, and negatively impacts the turnaround time for developing that section of code (and for any concurrent updates to the code base that may be dependent upon that change to the code base being accepted).

Verification or testing of software on an incremental basis (i.e., testing or verifying only the code being added or changed) might permit performing one or more test processes on only a new or newly revised section of code. This would be more efficient and presumably reduce the time and resources required for testing. However, presently known incremental verification tools for software have disadvantages related to their inability to properly deal with external dependencies (i.e., variable or parameter changes within the section of code being tested that are caused by code outside of the section undergoing the testing).

Thus a need exists for a reliable method of verifying the code contained in a complex software system as a code base is updated or modified during further development activities. Embodiments of the invention are directed toward solving these and other problems individually and collectively.

### SUMMARY

The terms “invention,” “the invention,” “this invention” and “the present invention” as used herein are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

Embodiments of the invention are directed to systems and methods for use in the development of software systems, applications, and platforms. Specifically, embodiments of the invention are directed to an efficient process for verifying or testing changes made to a code base for a software system. The inventive process provides the benefit of complete coverage obtained when using a verification process that is run over an entire software system, but with the efficiency associated with incremental software/code verification methods. In one embodiment, the inventive process involves constructing a map between the code base and a set of available verification tests, and then using that map to determine a subset of the available tests that are applicable to new or altered code. The invention also iteratively updates the map as new or changed code is added to the code base.

In one embodiment, the invention is directed to a method for verifying a proposed change to a set of source code, where the method includes

receiving the set of code representing the source code;

generating a baseline source code to testing code map representing an association between a unit of the source code and one or more units of a testing code;

selecting a proposed change to the source code;

using the baseline source code to testing code map to determine which unit or units of the testing code are applicable to the proposed change to the source code;

executing the unit or units of the testing code applicable to the proposed change to the source code;

generating an updated version of the baseline source code to testing code map; and

generating an updated version of the source code.

In another embodiment, the invention is directed to an apparatus for verifying a proposed change to a set of source code, where the apparatus includes

a processor programmed to execute a set of instructions;

a data storage element in which the set of instructions are stored, wherein when executed by the processor the set of instructions cause the apparatus to
receive the set of code representing the source code;
generate a baseline source code to testing code map representing an association between a unit of the source code and one or more units of a testing code;
select a proposed change to the source code;
use the baseline source code to testing code map to determine which unit or units of the testing code are applicable to the proposed change to the source code;
execute the unit or units of the testing code applicable to the proposed change to the source code;
generate an updated version of the baseline source code to testing code map; and
generate an updated version of the source code.

In yet another embodiment, the invention is directed to a system for providing data processing services to tenants of a multi-tenant data processing system, where the system includes

one or more business related data processing applications installed in the system and accessible by a plurality of tenants of the multi-tenant data processing system;

a data storage element accessible by a plurality of tenants of the multi-tenant data processing system;

a processor programmed with a set of instructions, wherein when executed by the processor the instructions cause the system to verify a proposed change to a source code for the multi-tenant data processing system by
receiving the set of code representing the source code;
generating a baseline source code to testing code map representing an association between a unit of the source code and one or more units of a testing code;
selecting a proposed change to the source code;
using the baseline source code to testing code map to determine which unit or units of the testing code are applicable to the proposed change to the source code;
executing the unit or units of the testing code applicable to the proposed change to the source code;
generating an updated version of the baseline source code to testing code map; and
generating an updated version of the source code.

Other objects and advantages of the present invention will be apparent to one of ordinary skill in the art upon review of the detailed description of the present invention and the included figures.

### BRIEF DESCRIPTION OF THE DRAWINGS

Embodiments of the invention in accordance with the present disclosure will be described with reference to the drawings, in which:

FIG. 1 is a diagram illustrating elements or components of an example computing or data processing environment with which an embodiment of the invention may utilized;

FIG. 2 is a diagram illustrating elements or components of an example Multi-Tenant Distributed Computing/Data Processing Platform with which an embodiment of the invention may be utilized;

FIGS. 3(a), 3(b), 3(c), and 3(d) are data flow diagrams illustrating an incremental software verification framework that may be used to implement one or more of the processes, methods, operations, or functions used in an embodiment of the invention;

FIG. 4 is a flow chart or flow diagram illustrating an example implementation of process or processor B1 of FIG. 3(a) that may be utilized in implementing an embodiment of the invention;

FIG. 5 is a flow chart or flow diagram illustrating an example implementation of process or processor B2 of FIG. 3(a) that may be utilized in implementing an embodiment of the invention;

FIG. 6 is a flow chart or flow diagram illustrating an example implementation of process or processor B3 of FIG. 3(a) that may be utilized in implementing an embodiment of the invention;

FIG. 7 is a flow chart or flow diagram illustrating an example implementation of a process for generating a test to source code map when the test or source code are not Java code, and that may be utilized in an embodiment of the invention;

FIG. 8 illustrates an example process that operates to invert a test to source code map to produce a source code to test map that can be input to processor B2 of FIG. 3(a) to assist with test selection, and that may be utilized in an embodiment of the invention; and

FIG. 9 is a diagram illustrating elements or components that may be present in a computing device, system, or platform configured to implement a method, process, function, or operation in accordance with an embodiment of the invention.

Note that the same numbers are used throughout the disclosure and figures to reference like components and features.

### DETAILED DESCRIPTION

This description discusses illustrative embodiments of the inventive system and methods for the integration and verification of changes made to the code base of a software system. It is presented with reference to the accompanying drawings in order to provide a person having ordinary skill in the relevant art with a full, clear, and concise description of the subject matter defined by the claims which follow, and to enable such a person to appreciate and understand how to make and use the invention. However, this description should not be read to limit the scope of the claimed subject matter, nor does the presence of an embodiment in this description imply any preference of the described embodiment over any other embodiment, unless such a preference is explicitly identified herein. It is the claims, not this description or other sections of this document or the accompanying drawings, which define the scope of the subject matter to which the inventor and/or the inventor's assignee(s) claim exclusive entitlement.

The subject matter of one or more embodiments of the invention is described herein with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying or requiring any particular order or arrangement among or between various steps or elements except when the order of individual steps or arrangement of elements is explicitly required.

Embodiments of the invention will be described more fully herein with reference to the accompanying drawings, which form a part hereof, and which show, by way of illustration, exemplary embodiments by which the invention may be implemented and practiced. The invention may, however, be embodied in different forms and should not be construed as limited to the embodiments set forth herein; rather, these embodiments are provided so that this disclosure will be thorough and complete, and will convey the scope of the invention to those skilled in the art.

Among other embodiments, the invention may be embodied in whole or in part as a system, as one or more processes, operations, methods, or functions, or as one or more apparatuses or devices. Embodiments of the invention may take the form of an entirely hardware implemented embodiment, an entirely software implemented embodiment or an embodiment combining software and hardware aspects. For example, in some embodiments, one or more of the operations, functions, processes, or methods described herein may be implemented by a suitable processing element (such as a processor, microprocessor, CPU, controller, etc.) that is programmed with a set of executable instructions (e.g., software instructions), where the instructions may be stored in a suitable data storage element. The processor, microprocessor, CPU or controller may be a component or element of a computing device or data processing device or platform, such as a software development environment, client device, or server (typically with an associated data storage or database). In some embodiments, one or more of the operations, functions, processes, or methods described herein may be implemented by a specialized form of hardware, such as a programmable gate array, application specific integrated circuit (ASIC), or the like. The following detailed description is, therefore, not to be taken in a limiting sense.

Embodiments of the present invention are directed to systems, apparatuses, and methods for use in developing software and in testing or otherwise verifying proposed changes to a code base. Embodiments of the invention may be implemented as part of a software development environment or platform in which developers maintain, modify, and provide corrections for a complex software system. Embodiments of the invention enable new code or modifications to existing code to be introduced into the software system in an efficient manner while ensuring that all impacted syntactic elements/sub-routines/modules are considered when verifying the operation of the new or modified code.

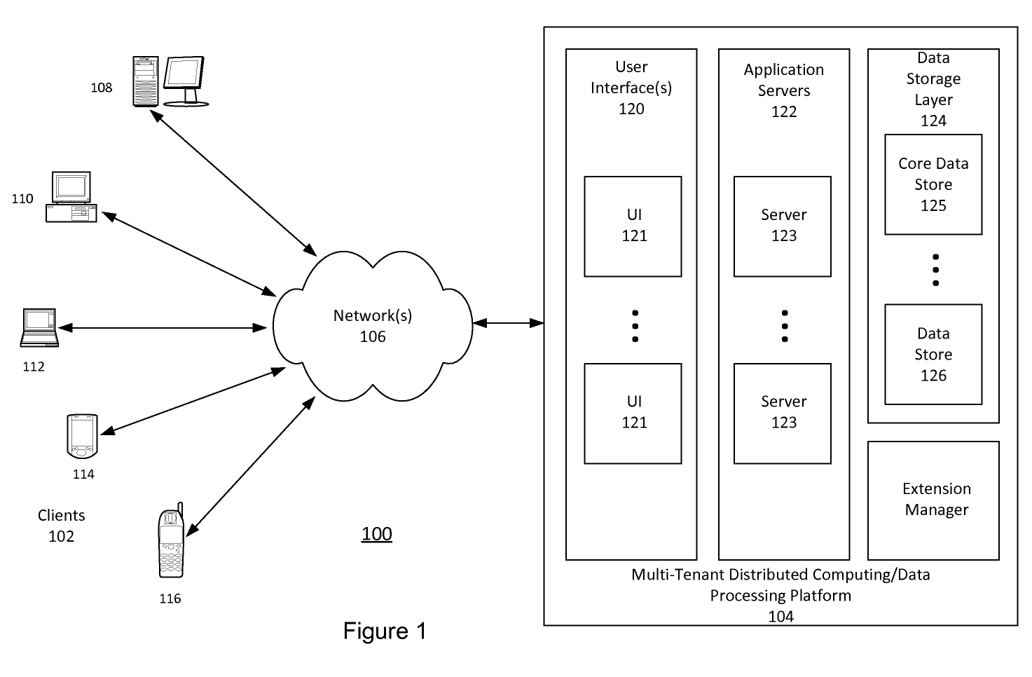

FIG. 1 is a diagram illustrating elements or components of an example computing or data processing environment 100 with which an embodiment of the invention may be utilized. A variety of clients 102 incorporating and/or incorporated into a variety of computing devices may communicate with a multi-tenant distributed computing/data processing platform 104 through one or more networks 106. For example, a client may incorporate and/or be incorporated into a client application implemented at least in part by one or more of the computing devices. Examples of suitable computing devices include personal computers, server computers 108, desktop computers 110, laptop computers 112, notebook computers, personal digital assistants (PDAs) 114, smart phones 116, cell phones, and consumer electronics incorporating one or more computing device components, such as one or more processors. Examples of suitable networks include networks that utilize wired and/or wireless communication technologies and networks operating in accordance with any suitable networking and/or communications protocol (e.g., the Internet).

Multi-tenant distributed computing/data processing platform 104 may include multiple processing tiers or layers, including a user interface layer 120, an application layer 122 and a data storage layer 124. Each tier or layer may be implemented with a set of computers and/or computer components including processing elements that are incorporated into computing or data processing devices and that are programmed to execute a set of software instructions. The user interface layer 120 may maintain multiple user interfaces 121, including graphical user interfaces and/or web-based interfaces. The user interfaces 121 may include a default user interface for the platform, as well as one or more user interfaces customized by one or more tenants of the platform. The default user interface may include components enabling tenants to maintain custom user interfaces, provide platform extensions, and otherwise administer their participation in the services and functions provided by the platform. The Application Server layer 122 may include one or more servers 123 with each server programmed to execute one or more applications that provide business related or other functions to tenants of the platform (such as ERP, CRM, eCommerce functions or services). The data storage layer 124 may include a core service data store 125 as well as a data store 126 dedicated to each tenant. The data storage layer 124 may include one or more production data stores and one or more testing, validation and/or backup data stores. Data stores may be implemented with any suitable data storage technology including structured query language (SQL) based relational database management systems (RDBMS).

Note that although aspects or elements of one or more embodiments of the invention will be described with reference to the multi-tenant platform of FIG. 1, this platform represents only one example of a software development environment in which the invention may be implemented or used to maintain or modify a software system. In general, embodiments of the invention enable the efficient and comprehensive verification of new or modified software code that is part of a software system or platform, where such system or platform may be used to host one or more applications or functional modules for use by one or more users.

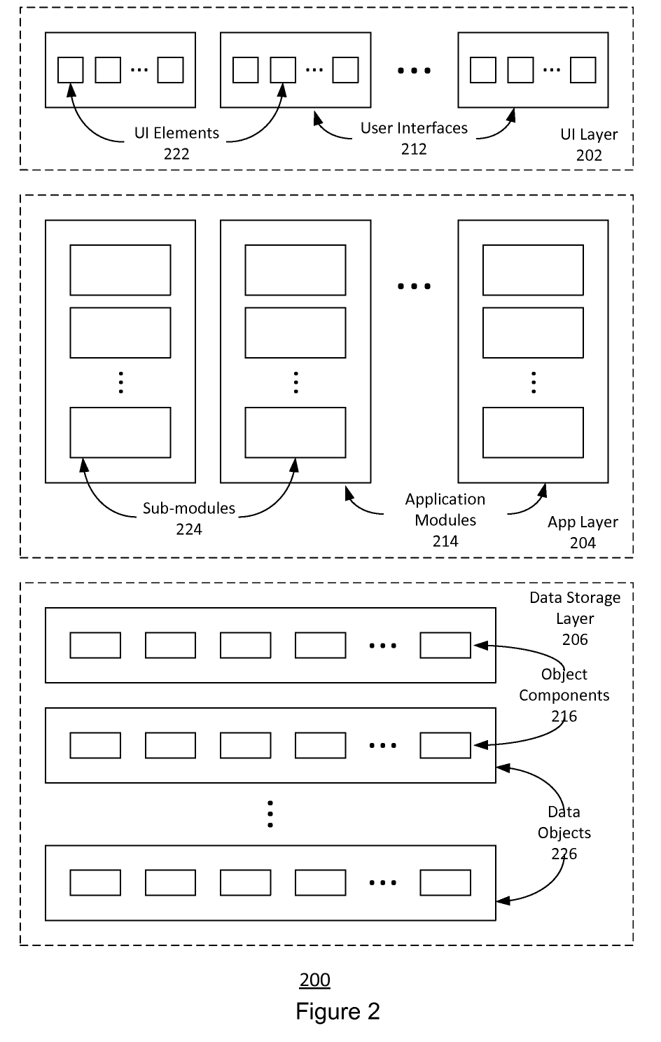

FIG. 2 is a diagram illustrating elements or components of an example Multi-Tenant Distributed Computing/Data Processing Platform 200 with which an embodiment of the invention may be utilized. The software architecture depicted in FIG. 2 represents an example of a software system to which an embodiment of the invention may be applied. In general, an embodiment of the invention may be applied to any set of software instructions that are designed to be executed by a suitably programmed processing element (such as a CPU, microprocessor, processor, controller, computing device, etc.). In a software system such instructions are typically arranged into “modules” with each such module performing a specific task, process, function, or operation. The entire set of modules may be controlled or coordinated in their operation by an operating system (OS) or other form of organizational platform.

The example architecture depicted in FIG. 2 includes a user interface (UI) layer or tier 202 having one or more user interfaces 212. Examples of such user interfaces include graphical user interfaces and application programming interfaces (APIs). Each user interface may include one or more interface elements 222. For example, users may interact with interface elements in order to access functionality and/or data provided by application 204 and/or data storage 206 layers of the example architecture. Examples of graphical user interface elements include buttons, menus, checkboxes, drop-down lists, scrollbars, sliders, spinners, text boxes, icons, labels, progress bars, status bars, toolbars, windows, hyperlinks and dialog boxes. Application programming interfaces may be local or remote, and may include interface elements such as parameterized procedure calls, programmatic objects and messaging protocols. Service platform extensions may extend the user interface layer by adding a new user interface, replacing an existing user interface and/or extending an existing user interface. An existing user interface may be extended by adding new interface elements, replacing interface elements and/or extending user interface elements.

The application (App) layer 204 may include one or more application modules 214 each having one or more sub-modules 224. The application modules and/or sub-modules may include any suitable computer-executable code such as computer-executable code corresponding to a programming language. For example, programming language source code may be compiled into computer-executable code. Alternatively, or in addition, the programming language may be an interpreted programming language such as a scripting language. Each application server may include each application module. Alternatively, different application servers may include different sets of application modules. Such sets may be disjoint or overlapping. Service platform extensions may extend the application layer by adding new application modules, replacing existing application modules and/or extending existing application modules. An existing application module may be extended by adding new sub-modules, replacing existing sub-modules and/or extending existing sub-modules.

The data storage layer 206 may include one or more data objects 226 each having one or more data object components 216 such as attributes and/or behaviors. For example, the data objects may correspond to tables of a relational database, and the data object components may correspond to columns or fields of such tables. Alternatively, or in addition, the data objects may correspond to data records having fields and associated services. Alternatively, or in addition, the data objects may correspond to persistent instances of programmatic data objects such as structures and classes. Each data store in the data storage layer may include each data object. Alternatively, different data stores may include different sets of data objects. Such sets may be disjoint or overlapping. Service platform extensions may extend the data storage layer by adding new data objects, replacing existing data objects and/or extending existing data objects. Existing data objects may be extended by adding new data object components, replacing existing data object components and/or extending existing data object components.

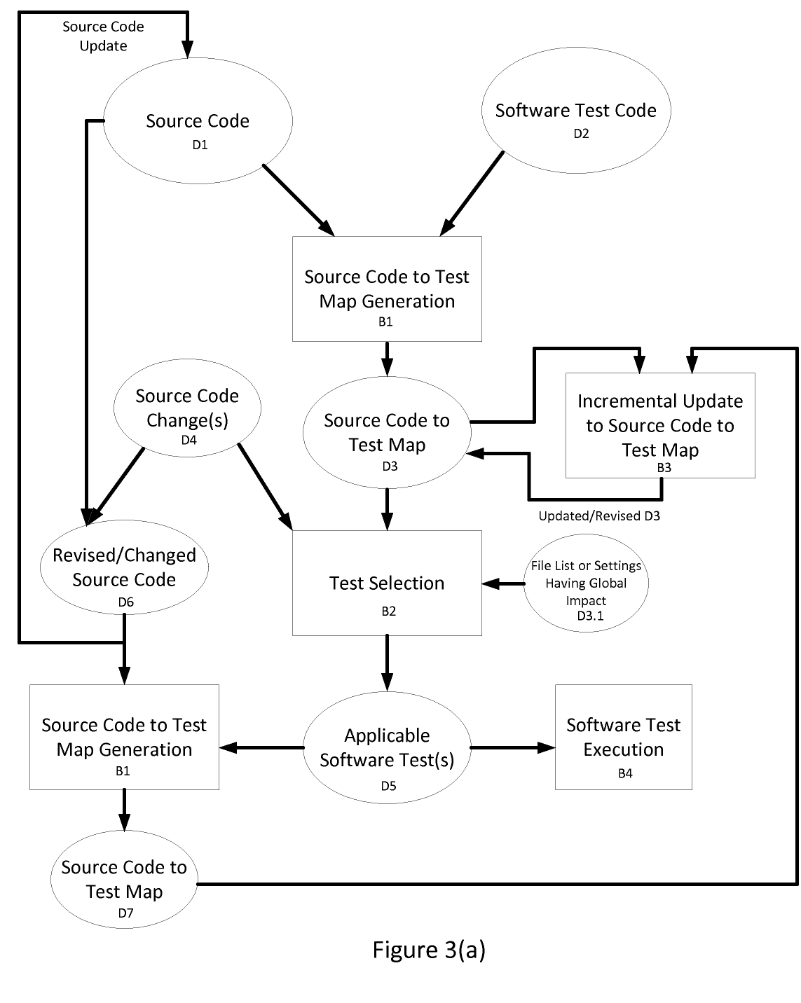

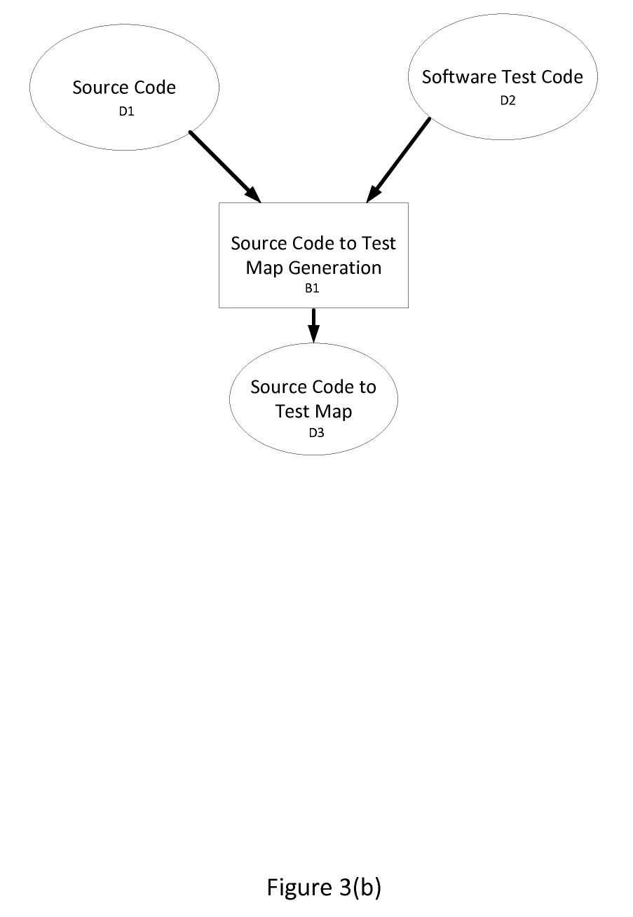

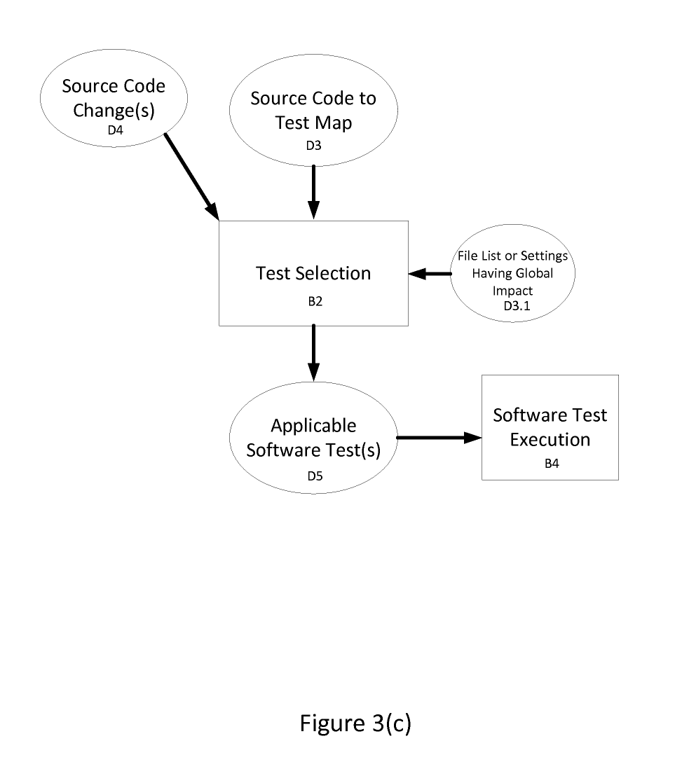

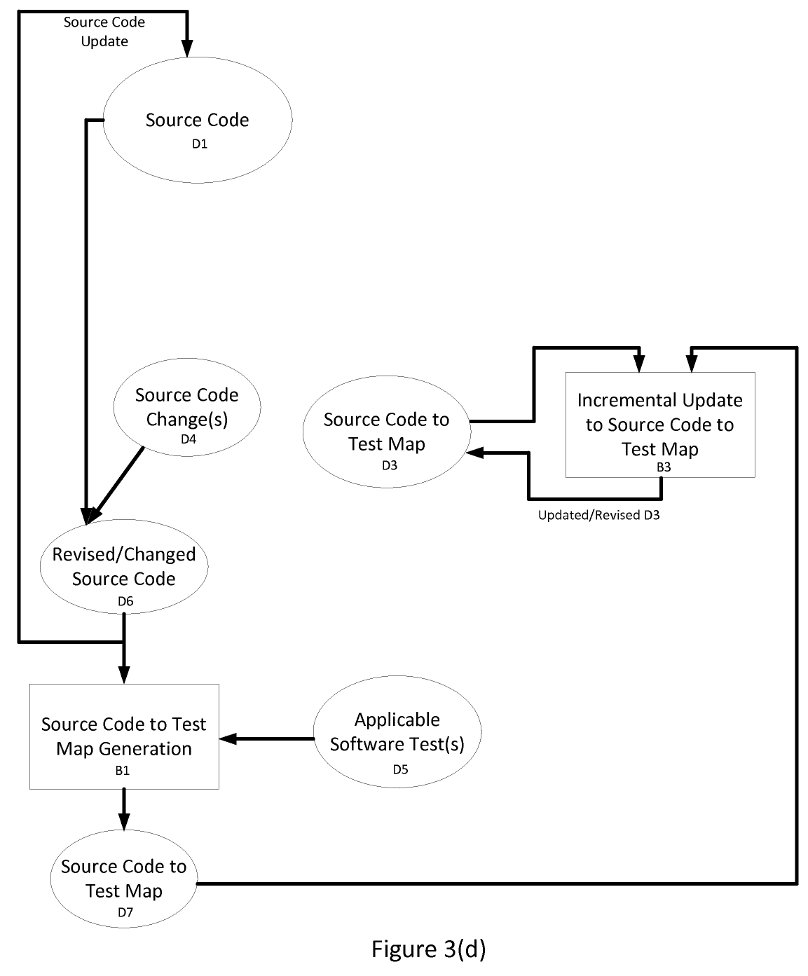

FIGS. 3(a), 3(b), 3(c), and 3(d) are data flow diagrams illustrating an incremental software verification framework that may be used to implement one or more of the processes, methods, operations, or functions used in an embodiment of the invention. Each figure depicts certain of the key functional relationships between the primary components of an embodiment of the invention. In the diagrams, an ellipse (or elliptical shape, exemplified by D1, D2, etc. in the figure) represents data and a rectangle (or rectangular shape, exemplified by B1, B2, etc. in the figure) represents the operation or function of a processor executing a set of instructions or code (i.e., a rectangle represents one or more operations or functions performed by a suitably programmed processing element that is executing a set of software instructions.).

Note that the processor executing a set of instructions/code or processing element may be part of a software development environment or platform, a multi-tenant data processing platform, or other computing system. In the case of a multi-tenant platform, an embodiment of the invention may be used to permit software revisions/upgrades to the platform's code base/source code and may be implemented as one or more of the software modules described with reference to FIG. 2.

In a broad sense, FIG. 3(a) illustrates an embodiment of the invention wherein (a) a base process uses the current contents of a code base or source code (D1) to create a map that represents an association between a unit of the code base/source code and one or more units of a body of software testing code (D2) that are applicable to the unit of code base/source code (as illustrated by elements D1, D2, B1, and output D3); and (b) a repeatable secondary process that iteratively determines one or more incremental changes to the map and to the utilized software testing code caused by a proposed change to the code base/source code (D4), followed by providing one or more of the changes to the map, changes to the applicable units of software testing code, or changes to the source code back into the base process to generate updated base process elements for the next iteration/cycle of the overall process (as illustrated by elements D4, D6, B3, and output D7, along with the feedback processes suggested by the arrows between D6 and D1, between D7 and B3, and between B3 and D3). In both the base process and subsequent iterations of the secondary process, software code (the code base/source code and/or a proposed change to the code base/source code) is used as an input to a process that determines which tests contained in the software test code (D2) are used to validate or verify the validity/correctness of the input code (as illustrated by elements D4, B2, and D3) so that appropriate software tests (D5) can be executed (as illustrated by B4).

In the embodiment shown in FIG. 3(a), the base process of the inventive method is shown as starting at process, method, function, or operation B1. B1 (e.g., a source code to test map generation process or processor) takes as an input D1 (source code) and as another input D2 (software test code), and produces as an output D3 (a source code to test map, data tree, data structure, or other suitable form of representation). Note that D3.1 represents a list of files or settings whose change can impact multiple code executions; if any of them are changed, it may be advisable to execute a full or fuller set of tests. The contents of list D3.1 may be provided by a developer or a suitable development tool.

When a developer or software engineer desires to make a change to a previously existing section of the code base (i.e., the source code) or desires to introduce a new module (e.g., sub-routine, syntactic element, etc.) or set of instructions, it is important to know which of an available set of verification or testing processes (such as those contained in D2) can be (and hence typically should be) used to test the new or revised code. The proposed change to the code base is represented as input D4 of FIG. 3(a). As shown in the figure, D4, D3, and D3.1 are input into process or processor B2 (a software test selection process or processor), and in response B2 outputs D5 (which is a set of one or more software tests applicable to D4, and which are typically a portion of the entire set of tests contained in D2). The developer can then choose to apply only this more limited set of tests (D5) in process or processor B4 (the software test executer) to verify the validity/correctness of the developer or engineer's code change(s) (D4), instead of having to execute all of the available set of tests.

Note that the input D4 may be one of several proposed changes to the Source Code/Code Base and the incremental aspects of the inventive processes may be executed for each proposed change. Similarly, one or more of the proposed changes may be used as inputs D4 for a sequence of incremental evaluations of the testing code applicable to each proposed change, followed by executing the Source Code/Code Base and other update processes (described in greater detail herein) before evaluating the remaining proposed changes. Thus, in each iteration or cycle of the set of inventive processes, one or more of a set of proposed code changes may be evaluated, followed by an update to the Source Code and the Source Code-to-Test Map, and then by the next “cycle” which evaluates the remaining code changes using the updated Source Code and Map.

Note also that the proposed change to the source code (D4) might affect the structure of the previously created source code to test map (D3). To address this possibility, processor or process B1 is also used to generate a new source code to test map for the code base that includes the new code, D4 (i.e., the new map takes into account the new code D4 and the tests applicable to that code, D5, as obtained from the operation of process B2 on input D4). To do this, process B1 operates to take the changed code D6 (a combination of D4 and D1) and D5 as inputs, and in response produces D7 (a source code to test map for the combined source code D6, formed from D4 and D1) as an output. Process B3 combines inputs D7 and D3, and in response operates to generate a new source code to test map (suggested by “Updated/Revised D3” in the figure) which is used to replace the previous version of D3, and thus takes into account the effect of the proposed source code change (D4). Note that D6 represents an updated or revised set of source code or code base and is provided back to the input D1 (as suggested by “Source Code Update” in the figure).

In a typical use case, for each proposed change/addition to the source code (such as D4), the processes/operations B2, B1, and B3 are executed (and if necessary repeated) to update the primary source code to test map D3 for the next iteration of the processes. The inventive processes permit process/processor B4 to run only the tests that are applicable to verify the correctness/validity of the proposed change(s). Thus, in one or more embodiments the invention operates with a relatively high efficiency because process B4 is only required to execute the applicable tests for one or more incremental Source Code changes D4, instead of an entire set of available tests. Note that as mentioned, the result of combining D1 and D4 (i.e., D6) is provided as an “update” or revision to the source code or code base (D1), which is then used as the primary source code or code base for the next iteration (i.e., a later cycle) of the inventive process.

Thus, in one embodiment, for each proposed change to the source code or code base D4, the inventive process or method may be described as:
(1) D4 is applied to D1, resulting in the new source code/code base D6;
(2) the tests applicable to D4 are selected by B2 (as D5);
(3) the tests specified by D5 are executed by B4 to verify D6;
(4) D7 is computed and merged with D3, to form the new D3 for later iterations; and
(5) D6 is treated as the new baseline D1 for the next iteration/cycle.
   Note that in general, it is desired to verify that D6 is correct/valid with respect to the tests contained in D2. However, as recognized by the inventors, by using an incremental verification process, it is only necessary to execute a sub-set of D2 (D5) in order to verify D6. As a result, if D6 is correct with respect to D5, then it is correct with respect to D2. Note that for each additional change D4, steps 1, 2, 3, 4, and 5 may be repeated.

FIGS. 3(b), 3(c), and 3(d) are data flow diagrams illustrating the different phases or aspects of the overall inventive process (which is illustrated in FIG. 3(a)). As shown in FIG. 3(b), the initial source code/code base is used to determine which software tests contained in Software Test Code D2 are relevant to evaluating/validating Source Code D1. This is accomplished by inputting D1 and D2 into process or processor B1, which results in output D3, the “baseline” Source Code-to-Test Map.

FIG. 3(c) illustrates the data flow for a phase, stage or step of the inventive process wherein a proposed change to the Source Code D4 is evaluated to determine which software tests or software test modules would be used to validate/verify D4. As shown in the figure, a proposed change to the Source Code/Code Base (D4) is input to the test selection process B2 (along with inputs D3 and D3.1). Test selection process or processor B2 determines the set of applicable tests or test code that would be used to evaluate D4, producing D5 as an output. This set of tests can then be executed by process or processor B4. As noted, this set of tests is expected to be smaller in many (if not most) cases than the set used to evaluate the entire Source Code/Code Base D1. Note that the output of B2 (i.e., D5) represents the set of tests needed to evaluate the proposed change D4, and is based on the “map” that was generated by considering the relationship(s) between D1 and D2.

FIG. 3(d) illustrates the data flow for a phase, stage or step of the inventive process wherein changes to the overall process caused by a previous cycle or iteration (such as those illustrated in FIG. 3(c) are used as part of a feedback mechanism to update Source Code D1 and Source Code-to-Test Map D3. As shown in the figure, D6 is determined and fed back into D1 to provide an update/revised version of the Source Code that includes the proposed change D4. Process or Processor B1 is executed on input D6 to generate D7, a Source Code-to-Test Code map that reflects the set of test code or tests code modules contained in D2 that would be used to validate/verify D6. Revised Source Code-to-Test Code map D7 is provided as an input to process or processor B3, which may also take D3 as an input. Process or processor B3 determines or constructs an updated/revised Source Code-to-Test Code map, which is then provided as a replacement or update to D3 (i.e., the D3 constructed as a result of the previous iteration/cycle).

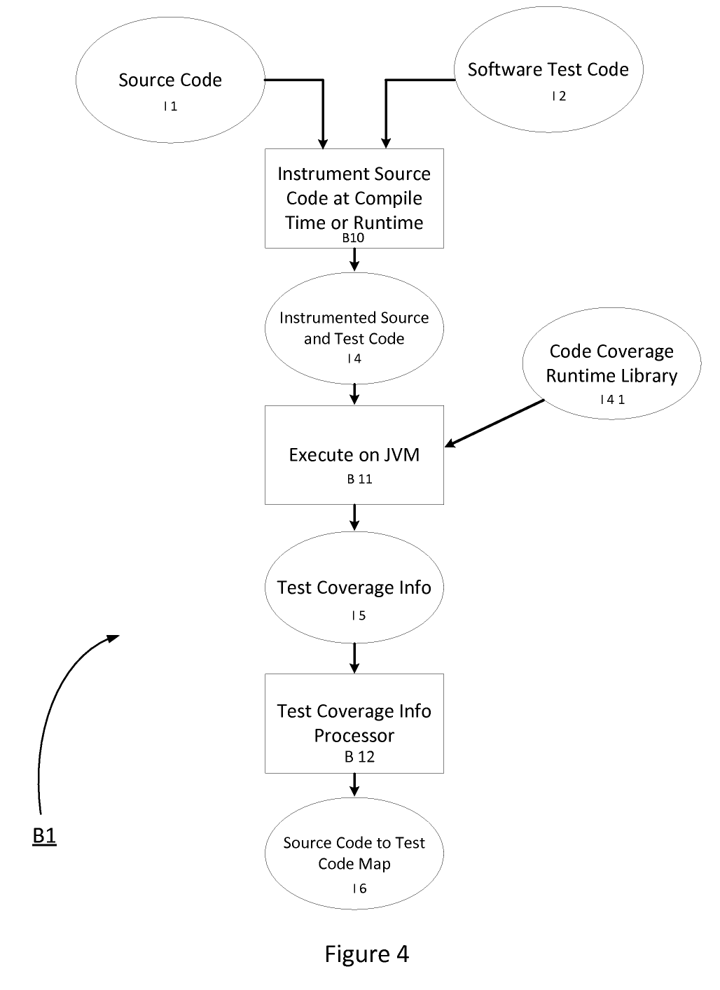

FIG. 4 illustrates a possible implementation of process or processor B1 of FIG. 3(a) that may be utilized in an embodiment of the invention. As shown in the figure, 11 (Source Code) and 12 (Software Test Code) are instrumented (i.e., provided with an ability to monitor or measure the level of the code's performance, diagnose errors, write trace information, etc.) by process or processor B10, either at compiler time or at runtime. 14 (Instrumented Source and Test Code) and 141 (Code Coverage Runtime Library) are then executed on JVM (Java Virtual Machine) (B11), with the test coverage information (15) being recorded during the execution and written onto disk (or other suitable data storage). B12 (a post processing component) takes 15 as input data and computes or otherwise determines the source code to test map (16) that represents the information regarding which source code is tested or verified by which available software test. An output of B12 is 16 (the source code to test map, data structure, list, file, etc.).

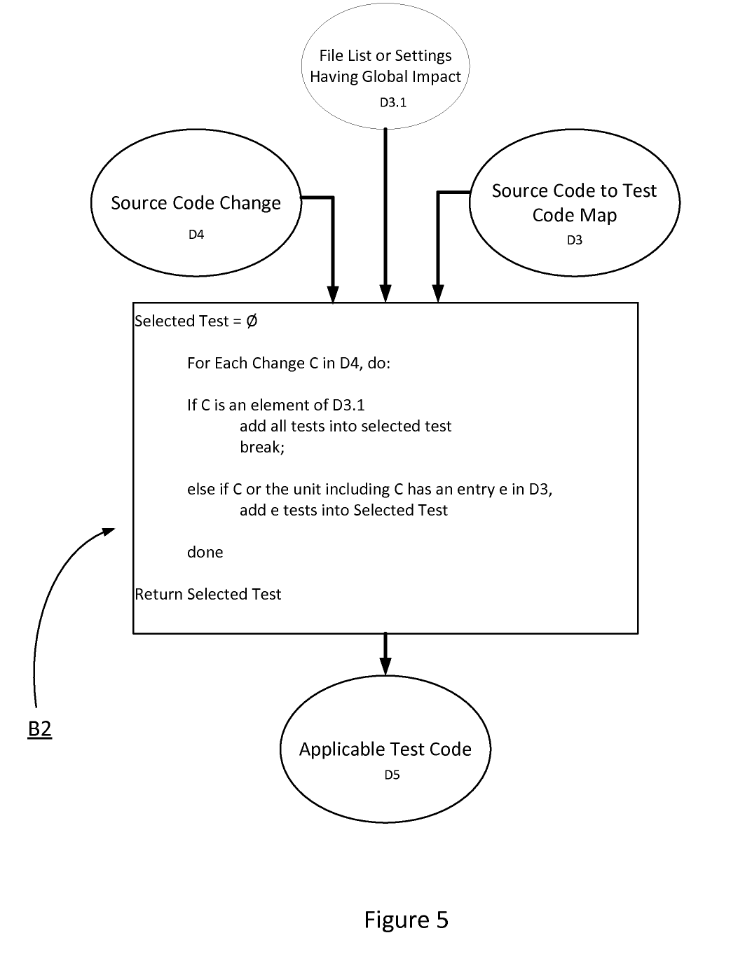

FIG. 5 illustrates certain of the operational details of process or processor B2 of FIG. 3(a) that may be utilized in an embodiment of the invention. Using the source code to test map (D3) and the list of files or settings that have global impact (D3.1) (which could be an empty list), it is possible to compute or otherwise determine the necessary tests for a given source code change (D4). The rectangle in the figure represents an example of an algorithm, heuristic, rules, or process that can be used to perform this task. The algorithm, heuristic, rules, or process takes D4, D3 and D3.1 as inputs. In one embodiment, for each change C in D4, the algorithm, heuristic, rules, or process determines if C is in D3.1, and if so, then it selects all tests; otherwise it determines the tests that test (or otherwise apply to the verification of) C; this group of tests are then collected and returned as D5.

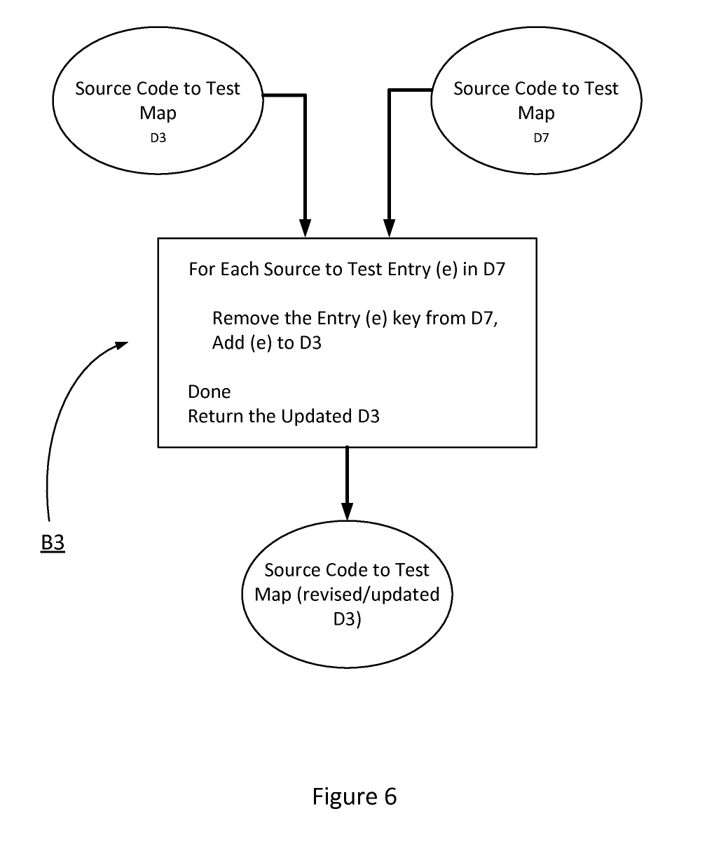

FIG. 6 illustrates certain of the operational details of process or processor B3 of FIG. 3(a) that may be utilized in an embodiment of the invention. In the figure, D3 represents the source code to test map that captures the relationships prior to the proposed changes to the code base represented by D4. D7 represents the source code to test map that captures the relationships after addition of the proposed changes to the code base represented by D4 (as illustrated in FIG. 3(a)). The algorithm, heuristic, rules, or process represented by the rectangle in FIG. 6 takes the two maps as inputs and combines them into a revised map. In one embodiment, a suitable combining algorithm, heuristic, rule, or process that can be used to perform this task is:
For each source to test entry (e) in D7, remove the corresponding entry from D3, and add (e) into D3. The result is a revised or updated source code to test map that captures the source code to test relationships after the change represented by D4.

Certain of the preceding paragraphs describe the inventive incremental verify process or processor as applied to a “class” level of granularity of the code. However, note that the inventive method(s) may also be applied to other levels of granularity, such as to a method level, to a statement level, or to an expression level. For example, for an incremental verify process or processor applied to an expression level of granularity of the code, if only an expression is changed, then only the tests that test the expression are needed to verify the change. There is expected to be no technical difficulty in implementing the inventive incremental verify process or processor at a finer level of granularity of the code; note however, that a parser might need to be used to partition the source code to components at a finer level of granularity.

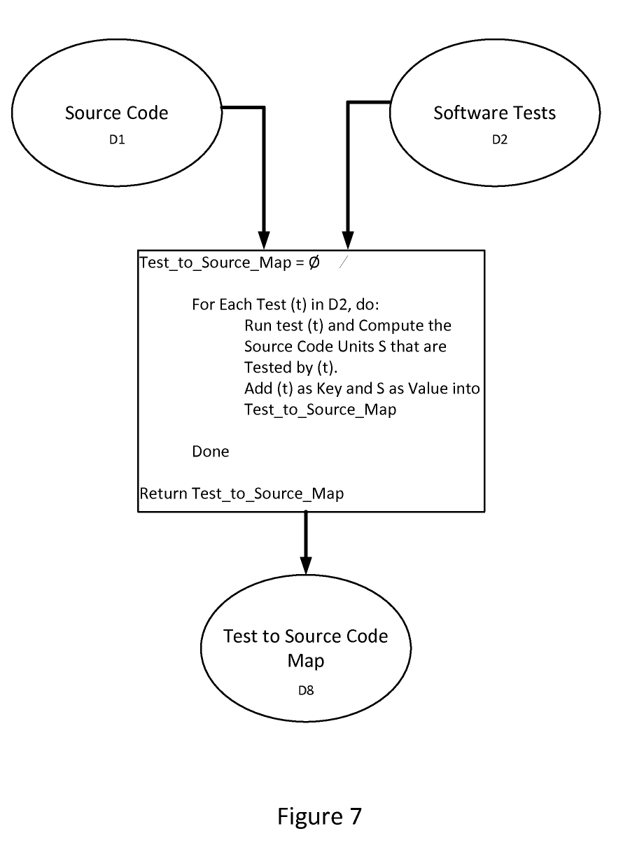

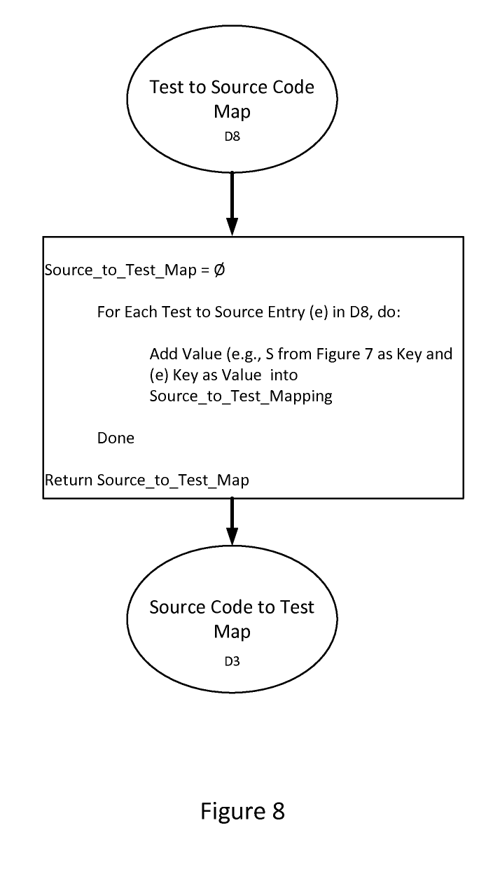

Note that in some situations, the software tests or source code may not be expressed as Java code (i.e., as process-able using a Java Virtual Machine), as has been assumed in describing the process illustrated in FIG. 4. However, as will be described with reference to FIGS. 7 and 8, the inventive methods for incremental verification of software code may still be utilized. FIG. 7 and FIG. 8 show how the inventive methods may be implemented for this more general case. FIG. 7 illustrates an example process for generating a test to source code map when the test or source code are not Java code and that may be utilized in an embodiment of the invention. FIG. 8 illustrates an example process that operates to invert a test to source code map to produce a source code to test map that can be input to processor B2 of FIG. 3(a) to assist with test selection, and that may be utilized in an embodiment of the invention.

In FIG. 7, D1 represents the complete source code, and D2 represents the complete set of software tests. For each test (t) in D2, the processor runs t independently and then computes the source code tested by t. The test (t) and the tested source code (S) are added as an entry into a test to source map. After all tests (t) are processed, the output is D8, a completed test to source code map (e.g., a data record, set of database entries, etc.).

A map inversion process or processor (shown in the rectangle in FIG. 8) may then be used to convert D8 to D3 (which is used in the process described with Reference to FIG. 3(a)). In this process, for each entry (e) in D8, e is inverted and added into a source to test map (e.g., the “Key” becomes a “Value” and the corresponding Value becomes a Key). The eventual output is D3 a source code to test map. Viewed this way, the process illustrated in FIG. 7 and the process illustrated in FIG. 8 together constitute another embodiment or implementation of the operations performed by process or processor B1 of FIG. 3(a), and support the more general cases when the software tests or source code are not Java.

Note that in some situations, a third party software development tool may be used to output a test to source code map such as D8 in FIG. 7, where D8 must be inverted to produce D3 (as described with reference to FIG. 8). Combining such a third party tool and the process illustrated in FIG. 8 may therefore provide another embodiment of process or processor B1. Note that this embodiment may have a lower implementation cost than one or more of the other options.

As described herein, an inefficient approach to verifying a relatively large software system involves running a series of verification tests over the entire set of code contained in the system. As noted, if these tests are time consuming and if several different development branches need to be verified, then the testing process itself can represent a significant operational cost. It can also become a developmental bottleneck for an organization attempting to modify the software system. Embodiments of the invention can dramatically reduce the operational costs of software development by improving the efficiency of continuous integration of new or revised code into a code base. In some embodiments, this is accomplished by incrementally verifying only those portions of the source code that can be affected by the set of code changes under test.

In some embodiments, the invention operates by establishing a mapping or other form of relationship between two sets of code. The first set may be referred to as source code; this is the code that is being tested or otherwise checked before it is added to a code base. The second set may be referred to as tests (more commonly called software test cases or unit tests). This is a set of code that is available for use in verifying the source code. Both the source code and test code may be represented as well-defined discrete subunits; for example, classes may be used, although other subdivision methods or characterizations may also be used. Next, the invention performs a full set of the available tests by executing all of the tests, and uses code coverage processes to record each subunit of source code that is exercised by each subunit of tests. This data may then be used to construct a test to source map or other form of data structure. This map may then be inverted to produce a source code to test map.

In some embodiments, the inventive incremental verification process may then proceed as follows: a proposed change to the source code is received and using the source code to test map, the tests that are exercised by the proposed change are run, rather than the full set of available tests. For a relatively large software system, this will typically be a relatively small set of tests.

Depending on operational requirements or administrative preferences, in some embodiments, new tests may always be run when evaluating a proposed source code change. In some embodiments, certain classes of changes (e.g., changes to an underlying database schema) may trigger a full verification run of the available tests. In some embodiments, the system may be operated conservatively (in the sense that issues of use or non-use are biased to resolve ambiguities in favor of running verifications or tests, rather than not running them). Finally, it is useful to note that the larger the set of source code and/or the more extensive the set of tests, the more advantageous it is to utilize the inventive incremental verification system.

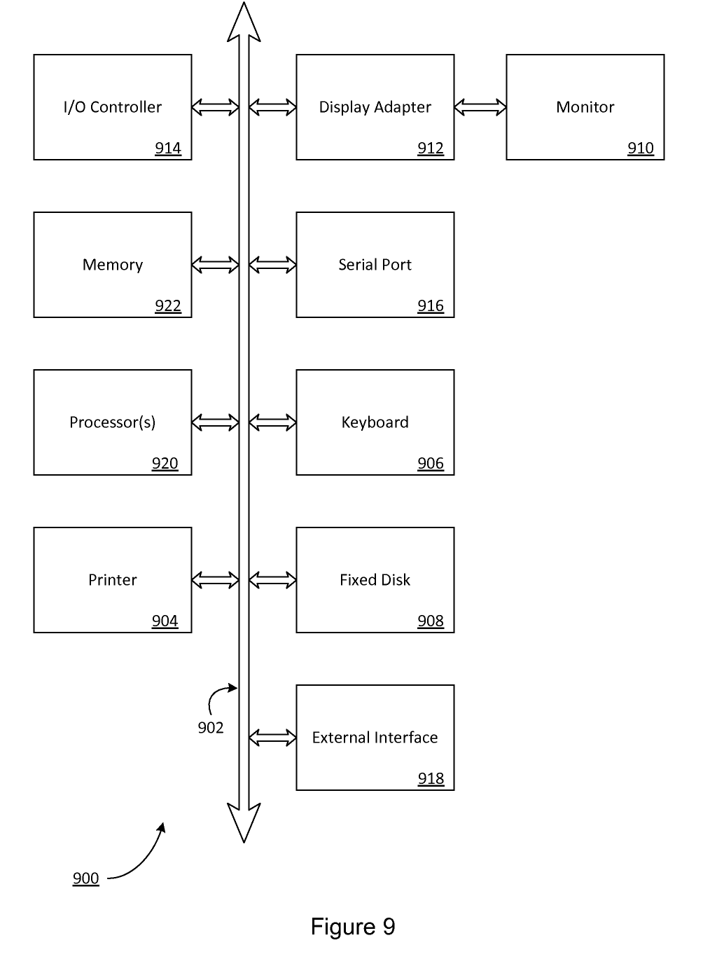

In accordance with at least one embodiment of the invention, the system, apparatus, methods, processes, operations, or functions for performing verification of incremental changes to a code base may be wholly or partially implemented in the form of a set of instructions executed by one or more programmed computer processors such as a central processing unit (CPU) or microprocessor. Such processors may be incorporated in an apparatus, server, client, software development environment, or other computing or data processing system, platform or device operated by, or in communication with, other components of the system. As an example, FIG. 9 is a diagram illustrating elements or components that may be present in a computing device, system, or platform 900 configured to implement a method, process, function, or operation in accordance with an embodiment of the invention. The subsystems shown in FIG. 9 are interconnected via a system bus 902. Additional subsystems include a printer 904, a keyboard 906, a fixed disk 908, and a monitor 910, which is coupled to a display adapter 912. Peripherals and input/output (I/O) devices, which couple to an I/O controller 914, can be connected to the computer system by any number of means known in the art, such as a serial port 916. For example, the serial port 916 or an external interface 918 can be utilized to connect the computer device 900 to further devices and/or systems not shown in FIG. 9 including a wide area network such as the Internet, a mouse input device, and/or a scanner. The interconnection via the system bus 902 allows one or more processors 920 to communicate with each subsystem and to control the execution of instructions that may be stored in a system memory 922 and/or the fixed disk 908, as well as the exchange of information between subsystems. The system memory 922 and/or the fixed disk 908 may embody a tangible computer-readable medium.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components, processes or functions described in this application may be implemented as software code to be executed by a processor using any suitable computer language such as, for example, Java, JavaScript, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments of the invention and does not pose a limitation to the scope of the invention unless otherwise claimed. No language in the specification should be construed as indicating any non-claimed element as essential to each embodiment of the present invention.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

1. A method for verifying a proposed change to a set of source-code, comprising:
receiving the set of code representing source-code;
generating a baseline map of source-code to testing-code representing an association between a unit of source-code and one or more units of a testing-code;
selecting a proposed change to the source-code;
using the baseline map of source-code to testing-code to determine which unit or units of the testing-code are applicable to the proposed change to the source-code;
executing the unit or units of the testing-code applicable to the proposed change to the source-code;
generating an updated version of the baseline map of source-code to testing-code in response to an implementation of the proposed change, wherein the updated version of the baseline map of source-code to testing-code is generated by limiting comparison of source-code to testing-code to that of the source-code and testing-code associated with the proposed change; and
generating an updated version of the source-code.

2. The method of claim 1, wherein the unit of the source-code is one of an executable instruction or a syntactic element containing a plurality of executable instructions.

3. The method of claim 1, further comprising repeating the steps or stages of using the baseline map of source-code to testing-code to determine which unit or units of the testing-code are applicable to the proposed change to the source-code and executing the unit or units of the testing-code applicable to the proposed change to the source-code for a second proposed change to the source-code prior to generating an updated version of the baseline map of source-code to testing-code and generating an updated version of the source-code.

4. The method of claim 1, further comprising repeating the steps or stages of using the baseline map of source-code to testing-code to determine which unit or units of the testing-code are applicable to the proposed change to the source-code and executing the unit or units of the testing-code applicable to the proposed change to the source-code for a second proposed change to the source-code after generating an updated version of the baseline map of source-code to testing-code and generating an updated version of the source-code.

5. The method of claim 1, wherein the baseline map of source-code to testing-code is generated by a method comprising:
generating a testing-code to source-code map; and
inverting the testing-code to source-code map.

6. The method of claim 1, wherein using the baseline map of source-code to testing-code to determine which units of the testing-code are applicable to the proposed change to the source-code further comprises:
inputting a unit of the proposed change to the source-code to a test selection process;
inputting a set of parameters or variables having global impact into the test selection process; and
operating the test selection process to determine which unit or units of testing-code are applicable to the inputs to the test selection process based on the baseline map of source-code to testing-code map.

7. An apparatus for verifying a proposed change to a set of source-code, comprising:
a processor programmed to execute a set of instructions;
a data storage element in which the set of instructions are stored, wherein when executed by the processor the set of instructions cause the apparatus to
receive the set of code representing source-code;
generate a baseline map of source-code to testing-code representing an association between a unit of the source-code and one or more units of a testing-code;
select a proposed change to the source-code;
use the baseline map of source-code to testing-code to determine which unit or units of the testing-code are applicable to the proposed change to the source-code;
execute the unit or units of the testing-code applicable to the proposed change to the source-code;
generate an updated version of the baseline map of source-code to testing-code in response to an implementation of the proposed change, wherein the updated version of the baseline map of source-code to testing-code is generated by limiting comparison of source-code to testing-code to the source-code and testing-code associated with the proposed change; and
generate an updated version of the source-code.

8. The apparatus of claim 7, wherein the unit of the source-code is one of an executable instruction or a syntactic element containing a plurality of executable instructions.

9. The apparatus of claim 7, wherein the set of instructions further cause the apparatus to use the baseline map of source-code to testing-code to determine which unit or units of the testing-code are applicable to the proposed change to the source-code and executing the unit or units of the testing-code applicable to the proposed change to the source-code for a second proposed change to the source-code prior to generating an updated version of the baseline map of source-code to testing-code and generating an updated version of the source-code.

10. The apparatus of claim 7, wherein the set of instructions further cause the apparatus to use the baseline map of source-code to testing-code to determine which unit or units of the testing-code are applicable to the proposed change to the source-code and executing the unit or units of the testing-code applicable to the proposed change to the source-code for a second proposed change to the source-code after generating an updated version of the baseline map of source-code to testing-code and generating an updated version of the source-code.

11. The apparatus of claim 7, wherein the set of instructions further cause the apparatus to generate the baseline map of source-code to testing-code by:
generating a testing-code to source-code map; and
inverting the testing-code to source-code map.

12. The apparatus of claim 7, wherein the set of instructions further cause the apparatus to use the baseline map of source-code to testing-code to determine which units of testing-code are applicable to the proposed change to the source-code by:
inputting a unit of the proposed change to the source-code to a test selection process;
inputting a set of parameters or variables having global impact into the test selection process; and
operating the test selection process to determine which unit or units of testing-code are applicable to the inputs to the test selection process based on the baseline map of source-code to testing-code map.

13. A system for providing data processing services to tenants of a multi-tenant data processing system, comprising:
one or more business related data processing applications installed in the system and accessible by a plurality of tenants of the multi-tenant data processing system;
a data storage element accessible by a plurality of tenants of the multi-tenant data processing system;
a processor programmed with a set of instructions, wherein when executed by the processor the instructions cause the system to verify a proposed change to a source-code for the multi-tenant data processing system by
receiving the set of code representing source-code;
generating a baseline map of source-code to testing-code representing an association between a unit of the source-code and one or more units of a testing-code;
selecting a proposed change to the source-code;
using the baseline map of source-code to testing-code to determine which unit or units of the testing-code are applicable to the proposed change to the source-code;
executing the unit or units of the testing-code applicable to the proposed change to the source-code;
generating an updated version of the baseline map of source-code to testing-code in response to an implementation of the proposed change, wherein the updated version of the baseline map of source-code to testing-code is generated by limiting comparison of source-code to testing-code to the source-code and testing-code associated with the proposed change; and
generating an updated version of the source-code.

14. The system of claim 13, wherein the unit of the source-code is one of an executable instruction or a syntactic element containing a plurality of executable instructions.

15. The system of claim 13, wherein the set of instructions further cause the system to use the baseline map of source-code to testing-code to determine which unit or units of the testing-code are applicable to the proposed change to the source-code and executing the unit or units of the testing-code applicable to the proposed change to the source-code for a second proposed change to the source-code prior to generating an updated version of the baseline map of source-code to testing-code and generating an updated version of the source-code.

16. The system of claim 13, wherein the set of instructions further cause the system to use the baseline map of source-code to testing-code determine which unit or units of the testing-code are applicable to the proposed change to the source-code and executing the unit or units of the testing-code applicable to the proposed change to the source-code for a second proposed change to the source-code after generating an updated version of the baseline map of source-code to testing-code and generating an updated version of the source-code.

17. The system of claim 13, wherein the set of instructions further cause the system to generate the baseline map of source-code to testing-code by:
generating a testing-code to source-code map; and
inverting the testing-code to source-code map.

18. The system of claim 13, wherein the set of instructions further cause the system to use the baseline map of source-code to testing-code to determine which units of the testing-code are applicable to the proposed change to the source-code by:
inputting a unit of the proposed change to the source-code to a test selection process;
inputting a set of parameters or variables having global impact into the test selection process; and
operating the test selection process to determine which unit or units of testing-code are applicable to the inputs to the test selection process based on the baseline map of source-code to testing-code map.

19. The system of claim 13, wherein the one or more business related data processing applications installed in the system include an Enterprise Resource Planning (ERP) or a Customer Relationship Management (CRM) application.

20. The system of claim 13, wherein the set of instructions further cause the system to generate an updated version of the baseline map of source-code to testing-code by:
generating an incremented source-code to testing-code using a revised -source-code that includes one or more proposed changes to the source-code as an input; and
merging the incremented source-code to testing-code and the baseline map of source-code to testing-code map.
